(19) United States
(12) Patent Application Publication
(10) Pub. No.: US 2006/0249968 A1
(43) Pub. Date: Nov. 9, 2006

(54) Chrome grill for mirror

(76) Inventor: Taylor Christopher Carthern, Atlanta, GA (US)

Correspondence Address: Taylor Carthern, 110 Old Fairburn Close, Atlanta, GA, 30331, US

(21) Appl. No.: 11/125,006

(22) Filed: May 9, 2005

(51) Int. Cl. B60R 13/00

(52) U.S. Cl. 296/1.08

(57) ABSTRACT

This present invention relates to having a grill for the outside of your mirror of your car or truck, or any other vehicle that matches the same grill that is on the front of your vehicle. You will also be able to change the existing grill on your car and get that matching grill for your mirror. We will have chrome plated grill that you can order and screw and/or glue onto your vehicle that matches your front grill. Some chrome grills will have the logo of your car on it that you can order with the logo on it and screw or/glue onto your car's mirror to match your car's logo on the front grill. Chrome grill on the mirror with light on the mirror on your vehicle. We will also have color grills for mirrors also including color plates. We will add mirror grills that will outline the mirror or cover the whole mirror, and it will match the front of the grill on your vehicle.

### BACKGROUND

### Field of Invention

This present invention relates to having a grill for the outside of your mirror of your car or truck, or any other vehicle that matches the same grill that is on the front of your vehicle. You will also be able to change the existing grill on your car and get that matching grill for your mirror. No one has ever made a mirror grill on the car that matches the grill on the front of the car. There is a need that we will fill with our design by providing owners of new and used vehicles with grills for there mirrors that will be made, with or without frames, painted or not painted, with or without light signals, color, any vehicle's logo on it, that comes fully with mirror, that you can screw and/or glue on, or pop on in the shape of a car mirror, with or without neon lights. For Example you have Cadillac with a grill on the front of the car with the Cadillac emblem. We created the chrome grill for it on the mirror that will have the same grill to match with the same Cadillac emblem.

### BACKGROUND OF INVENTION

This invention relates to the design of chrome grills on the front of vehicles and we will add mirror grills that will outline the mirror or cover the whole mirror, and it will match the front of the grill on your vehicle.

### DESCRIPTION OF RELATED INVENTIONS

For some car models they have on the front of the automobile they have grills, some which are chrome, that look great. But they are missing the matching design of the grill but on the mirrors.

### OBJECTS AND ADVANTAGES

Several of the advantages of my invention include:

1. Our design will enhance the design and style of all automobiles.

2. It will enhance the value of your automobile.

### SUMMARY OF INVENTION

This present invention relates to having a grill for the outside of your mirror of your car or truck, or any other vehicle that matches the same grill that is on the front of your vehicle. You will also be able to change the existing grill on your car and get that matching grill for your mirror. We will have chrome plated grill that you can order and screw and/or glue onto your vehicle that matches your front grill. Some chrome grills will have the logo of your car on it that you can order with the logo on it and screw or/glue onto your car's mirror to match your cars logo on the front grill. Chrome grill on the mirror with light on the mirror on your vehicle. We will also have color grills for mirrors also including color plates.

### BRIEF DESCRIPTION OF DRAWINGS

FIG. 1 displays the front of a Cadillac, showing the front chrome grill. FIG. 1-100 shows our invention with the matching chrome grill on the mirror of the vehicle. FIG. 1-200 displays the front grill that your manufacturer makes that we will complement with our new design.

FIG. 2 displays the front of a Cadillac and mirror by itself, showing the front chrome grill.

FIG. 2-100 shows our invention with the matching chrome grill on the mirror of the vehicle. FIG. 2-200 displays the front grill that your manufacturer makes that we will complement with our new design.

FIG. 3 displays the front grill of a Chrysler that has the mirrors to match. FIG. 3-100 shows the front grill of a Chrysler and FIG. 3-200 displays the matching grill for the mirror of the car.

FIG. 4 displays the front of a truck. FIG. 4-100 displays our new design with the grill that can have color and is chrome. FIG. 4-200 shows part of the front grill on the truck that matches the mirror and grill attached to the front of the truck. FIG. 4-300 shows the front chrome grill with fire design that matches our chrome mirrors for added style.

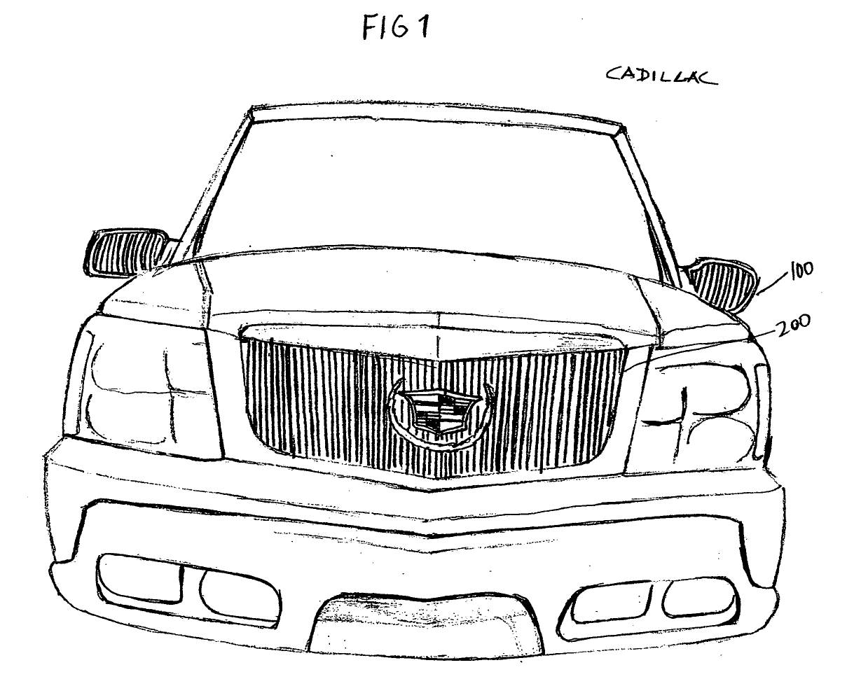

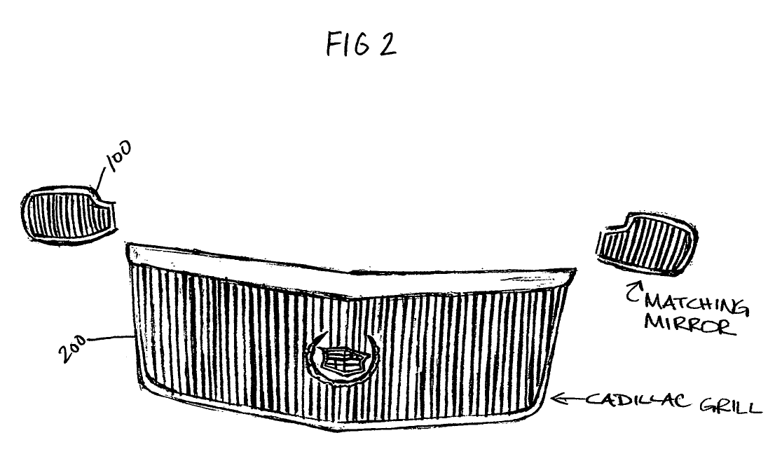

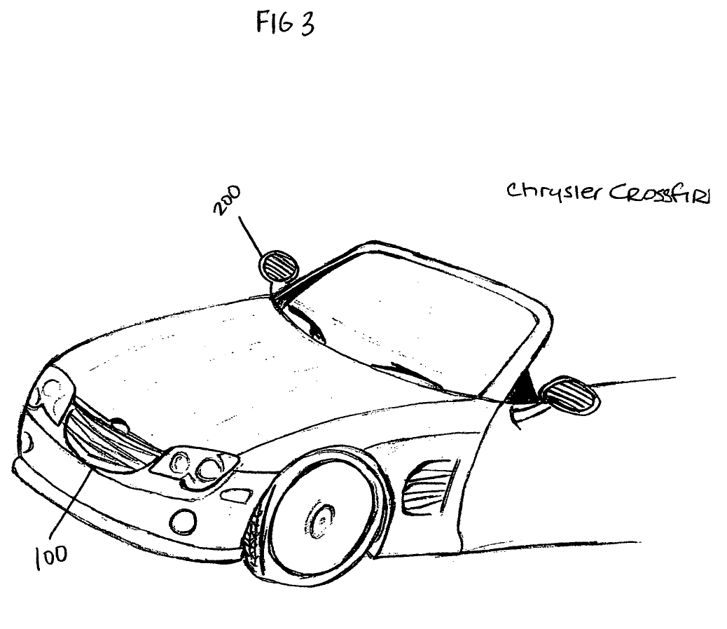

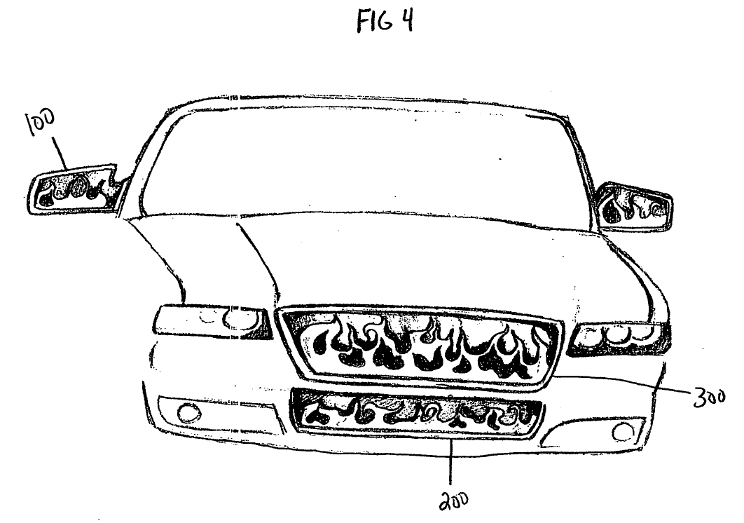

### DETAILED DESCRIPTIONS OF DRAWINGS

This present invention relates to having a grill for the outside of your mirror of your car or truck, or any other vehicle that matches the same grill that is on the front of your vehicle. You will also be able to change the existing grill on your car and get that matching grill for your mirror. We will have chrome plated grill that you can order and screw and/or glue onto your vehicle that matches your front grill. Some chrome grills will have the logo of your car on it that you can order with the logo on it and screw or/glue onto your car's mirror to match your cars logo on the front grill. Chrome grill on the mirror with light on the mirror on your vehicle. We will also have color grills for mirrors also including color plates. Some designs will color on both grills. If you have a truck with a grill that the design is fire, you can place that design with or without color onto the mirror that will match the front grill. We will also have some mirror grills made with and without frames and some with frames and no chrome grill but with a grill of color. Some grill will not be made of chrome but will be made of, iron, aluminum, chrome, mesh, all steel (including stainless), etc.

What I claim as my invention is:

1. A chrome but not limited to, iron, aluminum, all steel (including stainless), mesh, etc., covering the entire/whole mirror on your vehicle that matches the front grill of your automobile, and any grill on the mirror of a vehicle, in which the mirror will be seen from the inside of the car and the grill will be seen on the outside of the car on the other side of the mirror.

2. The grill with or without frames (outline the grill), painted or not painted, with or without light signals, from claim 1 that has lights on the grill on your entire/whole mirror.

3. The grill with or without frames (outline the grill), painted or not painted, with or without light signals, from claim 1 that contains your vehicle's logo on your entire/whole mirror grill that matches your vehicle's logo on the front grill.

4. The grill with or without frames (outline the grill), painted or not painted, with or without light signals, from claim 1 that has color grills on your entire/whole mirror.

5. A plated grill with or without frames (outline the grill), made of but not limited to, iron, aluminum, chrome, mesh, all steel (including stainless), with or without frames, with or without mesh, painted or not painted, with or without light signals, that matches the front grill of your automobile, in which the mirror will be seen from the inside of the car and the grill will be seen on the outside of the car on the other side of the mirror.

6. The plated grill with or without frames (outline the grill), painted or not painted, with or without light signals, from claim 5 that has lights on the grill on your mirror.

7. The plated grill with or without frames (outline the grill), painted or not painted, with or without light signals, from claim 5 that contains your vehicle's logo on your mirror grill that matches your vehicle's logo on the front grill.

8. The plated grill from claim 5 that has color grills with or without frames (outline the grill), painted or not painted, with or without light signals, on your mirror.

9. A plated grill from claim 5 with or without frames (outline the grill), painted or not painted, with or without light signals, that you can order and glue and or/screw onto your car that matches the front grill on your car.

10. A plated grill from claim 5 with or without frames (outline the grill), painted or not painted, with or without light signals, with your car's logo on it that you can order and glue and or/screw onto your car that matches the front grill on your car, with or without the matching logo.

11. A plated grill from claim 5 with or without frames (outline the grill), painted or not painted, with or without light signals, that will outline your mirror that you can order and glue and/or screw onto your car that matches the front grill on your car.

12. A plated mirror grill from claim 5, with or without frames (outline the grill), painted or not painted, with or without light signals, that will cover your mirror fully, that you can order and glue and/or screw onto your car that matches the front grill on your car.

13. A (entire/whole mirror) mirror grill, made of but not limited to, iron, aluminum, chrome, mesh, all steel (including stainless), with or without frames, with or without mesh, with or without frames (outline the grill), painted or not painted, with or without light signals, sold separately, on your vehicle that matches the front grill of your automobile.

14. The mirror grill from claim 13 that has lights with or without frames and with or without light signals, on the grill on your mirror.

15. The mirror grill with or without frames (outline the grill), painted or not painted, with or without light signals, sold separately, from claim 13 that contains your vehicle's logo on your mirror grill that matches your vehicle's logo on the front grill.

16. The mirror grill with or without frames (outline the grill), painted or not painted, with or without light signals, sold separately, from claim 13 that has color grills on your mirror.

17. The mirror grill from claims 1, 5, or 13, that can be used on all vehicles and automobiles, including cars, trucks, vans, and etc. (for new and used vehicles)

18. The design for any chrome plated grill and whole mirror grill from claims 1, 5, 13, in any shape including but not limited to circle, rectangle, triangle, square, octagon, oval, including with or without frames (outline the grill), painted or not painted, with or without light signals, color, any vehicle's logo, that comes fully with mirror, that you can screw and/or glue on, or pop on.

19. The design of a whole or plated mirror from claims 1, 5, or 13, with or without frames, painted or not painted, with or without light signals, color, any vehicle's logo, that comes fully with mirror, that you can screw and/or glue on, or pop on in the shape of a car mirror, with or without neon lights, made out, but not limited to, iron, aluminum, chrome, mesh, all steel (including stainless) with options comprising:
Manuel, Manuel Signal, Manual Dual Signal, Power, Power Dual, Power Dual Signal and Heated Mirrors.

20. Any plated or whole mirror that has grill from claims 1, 5, or 13, and frame that look like the grill on the front of that particular vehicle, and any car sold with a grill that has the mirror made out of, but not limited to, iron, aluminum, chrome, mesh, all steel (including stainless), with or without frames, with or without mesh, painted or not painted, with or without light signals, color, any vehicle's logo, that comes fully with mirror, that you can screw and/or glue on, or pop on in the shape of a car mirror, with or without neon lights, to match the grill on the front of the vehicle. (Some mirrors will be made with frames and the grill will be in the color of the vehicle of any other color.)
